(19) United States
(12) Patent Application Publication
(10) Pub. No.: US 2008/0309512 A1
(43) Pub. Date: Dec. 18, 2008

(54) GATE OPERATOR CAPABLE TO BE CONTROLLED AND DIAGNOSED VIA INTERNET

(75) Inventor: ZBIGNIEW STEIN, Jupiter, FL (US)

Correspondence Address: ZBIGNIEW STEIN, 9332 SANDY RUN RD., JUPITER, FL, 33478, US

(73) Assignee: ZBIGNIEW STEIN, JUPITER, FL (US)

(21) Appl. No.: 12/137,607

(22) Filed: Jun. 12, 2008

Related U.S. Application Data
(60) Provisional application No. 60/943,852, filed on Jun. 14, 2007.

(51) Int. Cl. G06F 13/42

(52) U.S. Cl. 340/825

(57) ABSTRACT

Disclosed is the gate operator that is able to be driven and diagnosed remotely via internet.

### BACKGROUND—FIELD OF INVENTION

This invention relates to the methods of controlling and diagnosing the gate operators.

### FEDERALLY SPONSORED RESEARCH

None

### SEQUENCE LISTING

None

### BACKGROUND—DESCRIPTION OF THE PRIOR ART

At present all of the gate operators are able to be driven and diagnosed locally. That makes necessary to bring the service personnel to the location in case of malfunction. With todays high price of gas very often it makes cost of yearly service higher and even much higher than the cost of purchase of the gate operator.

The present invention presents a solution that makes possible to control and diagnose the gate operator via internet remotely substantially cutting down maintenance cost.

Additionally the present invention allows to send a security data like the images of the passing cars and even the photographs of the drivers and passengers.

### SUMMARY OF INVENTION

The general idea of the invention is a gate operator that may be controlled and diagnosed via internet remotely by the highly trained manufacturer service personnel. They may instruct the local personnel what to do to solve the problem. In most cases it may be quite effective.

### OBJECTIVES AND ADVANTAGES

Several objectives and advantages are:

The ability to control and diagnose the gate operator via internet remotely.

The ability to collect and send an important security data like: license plates of the passing cars, the images of the passing cars and even the photographs of the drivers and passengers.

What is claimed is:

1. A gate operator comprising:
an electronic control system capable of driving and diagnosing said gate operator remotely via internet.
